(19) United States
(12) Patent Application Publication
(10) Pub. No.: US 2022/0320483 A1
(43) Pub. Date: Oct. 6, 2022

(54) ANODE FOR ALL-SOLID-STATE BATTERY CONTAINING NO ACTIVE MATERIAL AND ALL-SOLID-STATE BATTERY INCLUDING THE SAME

(71) Applicants: Hyundai Motor Company, Seoul (KR); Kia Corporation, Seoul (KR)

(72) Inventors: Yong Gu Kim, Suwon (KR); Hong Seok Min, Yongin (KR); Sang Heon Lee, Yongin (KR); Jae Min Lim, Suwon (KR); Sa Heum Kim, Suwon (KR); Yun Sung Kim, Seoul (KR); Woo Suk Cho, Seongnam (KR); Ji Sang Yu, Seongnam (KR); Goo Jin Jeong, Seongnam (KR); Kyung Su Kim, Yongin (KR)

(21) Appl. No.: 17/546,420

(22) Filed: Dec. 9, 2021

(30) Foreign Application Priority Data
Mar. 31, 2021 (KR) 10-2021-0041611

(51) Int. Cl. H01M 4/134; H01M 4/38; H01M 10/052; H01M 4/62; H01M 10/0585; H01M 4/02

(52) U.S. Cl. CPC H01M 4/134; H01M 4/38; H01M 10/052; H01M 4/625; H01M 10/0585; H01M 2004/021; H01M 2004/027

(57) ABSTRACT

Disclosed is an anode for an all-solid-state battery containing no active material. The anode for an all-solid-state battery includes an anode current collector, and a composite layer disposed on the anode current collector and including a carbon material and a metal capable of being alloyed with lithium. The carbon material includes a plurality of primary particles that do not agglomerate with one another.

### CROSS-REFERENCE TO RELATED APPLICATION

This application claims under 35 U.S.C. § 119(a) the benefit of priority to Korean Patent Application No. 10-2021-0041611, filed on Mar. 31, 2021, the entire contents of which are incorporated herein by reference.

### TECHNICAL FIELD

The present invention relates to an anode for an all-solid-state battery containing no active material.

### BACKGROUND

An all-solid-state battery has a three-layered laminate structure including a cathode active material layer bonded to a cathode current collector, an anode active material layer bonded to an anode current collector, and a solid electrolyte interposed between the cathode active material layer and the anode active material layer.

In general, an anode active material layer of an all-solid-state battery is formed by mixing an active material with a solid electrolyte for securing ionic conductivity. Such a conventional all-solid battery has lower energy density than a lithium ion battery since the solid electrolyte has a higher specific gravity than a liquid electrolyte.

In an attempt to increase the energy density of all-solid-state batteries, research has been conducted on the use of lithium metal as an anode. However, there are problems such as interfacial bonding, dendrite growth, price, and difficulty increasing the area thereof.

Recently, research has been made on an anodeless all-solid-state battery without an anode, in which lithium is directly deposited on an anode collector. However, the battery has a problem in that the rate of an irreversible reaction gradually increases due to non-uniform lithium precipitation, so the lifespan and durability thereof are seriously deteriorated.

The above information disclosed in this Background section is only for enhancement of understanding of the background of the invention, and therefore it may contain information that does not form the prior art that is already known in this country to a person of ordinary skill in the art.

### SUMMARY

In preferred aspects, provided is an anode material for increasing the lifespan of an anodeless all-solid-state battery.

The objects of the present invention are not limited to those described above. Other objects of the present invention will be clearly understood from the following description, and are able to be implemented by means defined in the claims and combinations thereof.

In one aspect, provided is an anode for an all-solid-state battery. The anode may include an anode current collector, and a composite layer disposed on the anode current collector and including a carbon material and a metal capable of being alloyed with lithium. The carbon material may include a plurality of primary particles that do not agglomerate.

The carbon material may include spherical particles.

The carbon material may have an average particle diameter of about 250 nm to about 350 nm.

The carbon material may have an electrical conductivity of about 30 S/m or less.

The carbon material may have a packing density of about 1.5 g/cc or greater.

The carbon material may have a BET specific surface area of about 25 m²/g or less.

The total pore volume of the carbon material, obtained through nitrogen adsorption isotherm measurement, may be about 0.001 cm³/g to 0.4 cm³/g.

The metal may include one or more selected from the group consisting of gold (Au), platinum (Pt), palladium (Pd), silicon (Si), silver (Ag), aluminum (Al), bismuth (Bi), tin (Sn), and zinc (Zn).

The composite layer may further include a binder, and may include an amount of about 50% to 70% by weight of the carbon material, an amount of about 20% to 40% by weight of the metal, and an amount of about 1% to 10% by weight of the binder, all % by weight is based on the total weight of the composite layer.

In another aspect, provided is an all-solid-state battery including a cathode, the anode as described herein, and a solid electrolyte layer interposed between the anode and the cathode. The solid electrolyte layer is stacked such that the solid electrolyte layer contacts a composite layer of the anode.

In a further aspect, a vehicle (including an electric-powered vehicle) is provided that comprises a battery as disclosed herein.

Other aspects of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 shows an exemplary all-solid-state battery according to an exemplary embodiment of the present invention;

FIG. 2 shows the state in which the all-solid-state battery according to an exemplary embodiment of the present invention is being charged;

FIG. 3A shows a scanning electron micrograph (SEM) image showing a carbon material in Example according to an exemplary embodiment of the present invention;

FIG. 3B shows a scanning electron micrograph (SEM) image showing a carbon material in Comparative Example 1;

FIG. 3C shows a scanning electron micrograph (SEM) image showing a carbon material in Comparative Example 2;

FIG. 3D shows a scanning electron micrograph (SEM) image showing a carbon material in Comparative Example 3;

FIG. 3E shows a scanning electron micrograph (SEM) image showing a carbon material in Comparative Example 4;

FIG. 4 shows results of analysis of isothermal adsorption-desorption characteristics of nitrogen gas regarding the composite layers in Example according to an exemplary embodiment of the present invention and Comparative Examples 1 to 4;

FIG. 5 shows a graph showing pore size distribution, derived using a Barrett-Joyner-Halenda (BJH) method based on the results of FIG. 4; and

FIG. 6 shows results of measurement of coulombic efficiency and lifespan of all-solid-state batteries according to Example and Comparative Examples 1 to 4.

### DETAILED DESCRIPTION

The objects described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by the present invention, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

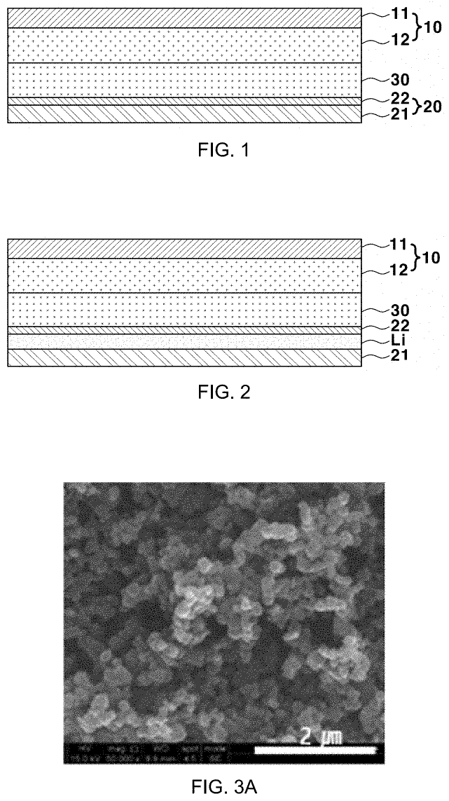

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. FIG. 1 shows a cross-sectional view showing an exemplary all-solid-state battery according to an exemplary embodiment of the present invention. As shown in FIG. 1, the all-solid-state battery may include: a cathode 10 including a cathode current collector 11 and a cathode active material layer 12; an anode 20 including an anode current collector 21 and a composite layer 22; and a solid electrolyte layer 30 disposed between the anode 10 and the cathode 20. The anode 20 and the solid electrolyte layer 30 may be stacked such that the composite layer 22 contacts the solid electrolyte layer 30.

The cathode current collector 11 may be a plate-shaped substrate having electrical conductivity. The cathode current collector 11 may include aluminum foil.

The cathode active material layer 12 may include a cathode active material, a solid electrolyte, a conductive material, a binder and the like.

The cathode active material may be an oxide active material or a sulfide active material.

The oxide active material may include a rock-salt-layer-type active material such as LiCoO₂, LiMnO₂, LiNiO₂, LiVO₂, or Li₁₊ₓNi_{1/3}Co_{1/3}Mn_{1/3}O₂, a spinel-type active material such as LiMn₂O₄ or Li(Ni_{0.5}Mn_{1.5})O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a portion of which is substituted with a heterogeneous metal such as LiNi_{0.8}Co_{(0.2-x)}AlₓO₂ (0<x<0.2), a spinel-type active material having a transition metal, a portion of which is substituted with a heterogeneous metal such as Li₁₊ₓMn_{2-x-y}M_{y}O₄ (wherein M includes at least one of Al, Mg, Co, Fe, Ni, Zn, and 0<x+y<2), and lithium titanate such as Li₄Ti₅O₁₂.

The sulfide active material may be copper Chevrel, iron sulfide, cobalt sulfide, nickel sulfide, or the like.

The solid electrolyte may suitably include an oxide solid electrolyte or a sulfide solid electrolyte. Preferably, a sulfide solid electrolytehaving high lithium ion conductivity may be used in the solid electrolyte layer 30. The sulfide solid electrolyte is not particularly limited, but may include one or more selected from the group consisting of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn and Ga), Li₂S—GeS₂, Li₂S—SiS₂—Li₃PO₄, Li₂S—SiS₂—LiₓMO_{y} (wherein x and y positive numbers and M is one of P, Si, Ge, B, Al, Ga, and In), and Li₁₀GeP₂S₁₂.

The conductive material may suitably include one or more selected from the group consisting of carbon black, conductive graphite, ethylene black, and graphene.

The binder may suitably include one or more selected from the group consisting of butadiene rubber (BR), nitrile butadiene rubber (NBR), hydrogenated nitrile butadiene rubber (HNBR), polyvinylidene difluoride (PVDF), polytetrafluoroethylene (PTFE), and carboxymethylcellulose (CMC).

The anode 20 includes an anode current collector 21 and a composite layer 22 disposed on the anode current collector 21.

The anode current collector 21 may be a plate-shaped substrate having electrical conductivity. The anode current collector 21 may include nickel (Ni), stainless steel (SUS), or combinations thereof.

The anode current collector 21 may be a high-density metal thin film having porosity lower than about 1%.

The anode current collector 21 may have a thickness of about 1 μm to 20 μm, or about 5 μm to 15 μm.

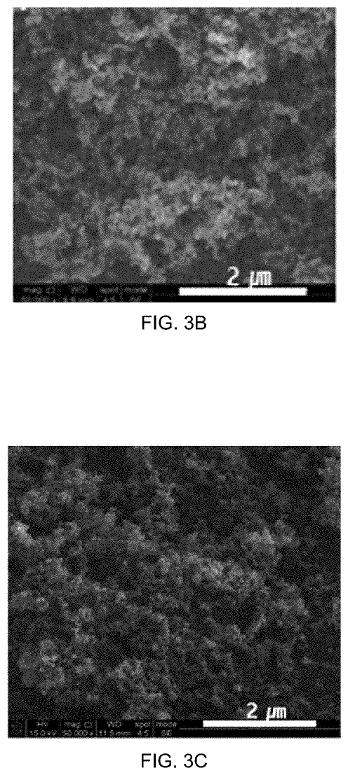

FIG. 2 shows a cross-sectional view showing the state in which the all-solid battery according to an exemplary embodiment of the present invention is being charged. As shown in FIGS. 1 and 2, lithium ions migrated from the cathode 10 during charging of the battery may be deposited and stored in the form of lithium metal (Li) between the composite layer 22 and the anode current collector 21.

The composite layer 22 may include a carbon material and a metal capable of being alloyed with lithium.

The carbon material may include a plurality of primary particles that do not agglomerate with one another. Here, the expression “carbon material includes primary particles” means that the carbon material does not include secondary particles formed by agglomeration of primary particles.

The carbon material may include spherical particles. By using spherical particles as the carbon material, the packing density of the composite layer 22 can be increased, and pores in the composite layer 22 can be minimized. Accordingly, a migration path of lithium ions is smoothly formed in the composite layer 22.

The carbon material may have an average particle diameter of about 250 nm to 350 nm. The average particle diameter may be a central particle diameter (D50), measured using a laser-light-scattering method. When the average particle diameter of the carbon material is greater than about 350 nm, the migration path of lithium ions in the composite layer 22 may increase and thus the transport kinetics of lithium ions may decrease.

The carbon material may have an electrical conductivity of about 30 S/m or less. The lower limit of the electrical conductivity is not particularly limited, and may be, for example, about 0.1 S/m or greater, about 1 S/m or greater, or about 10 S/m or greater. When the electrical conductivity of the carbon material is greater than about 30 S/m, lithium ions may be electrodeposited between the composite layer 22 and the solid electrolyte layer 30, resulting in the formation of dendrites or non-uniform lithium precipitation.

The carbon material may have a packing density of 1.5 g/cc or more. The upper limit of the packing density is not particularly limited, and may be, for example, about 8 g/cc or less, or about 5 g/cc or less, or about 3 g/cc or less. When the packing density is less than about 1.5 g/cc, excessive many pores may exist in the composite layer 22, so lithium ions may not move smoothly.

The carbon material may have a BET specific surface area of about 25 m²/g or less. The lower limit of the BET specific surface area is not particularly limited, and may be, for example, about 10 m²/g or greater or about 15 m²/g or greater. The BET specific surface area is a physical property that is closely related to the average particle diameter and shape of the carbon material, and the BET specific surface area increases as the average particle diameter of the carbon material decreases and the number of pores increases. Therefore, when the BET specific surface area is greater than about 25 m²/g, the packing density of the carbon material may be decreased, and thus lithium ions may not move smoothly in the composite layer 22.

The carbon material may have a total pore volume of about 0.001 cm³/g to 0.4 cm³/g, wherein the total pore volume is determined by measuring a nitrogen adsorption isotherm of the carbon material. When the total pore volume of the carbon material is greater than about 0.4 cm³/g, excessive many pores may exist in the composite layer 22 and thus lithium ions may not move smoothly.

The metal may include one or more selected from the group consisting of gold (Au), platinum (Pt), palladium (Pd), silicon (Si), silver (Ag), aluminum (Al), bismuth (Bi), tin (Sn), and zinc (Zn).

When the metal is incorporated into the composite layer 22, the lithium metal (Li) of FIG. 2 may be formed to be smoother and flatter.

The composite layer 22 may further include a binder. The binder may be a component configured to bond the components, such as the carbon material and metal, to each other.

The type of the binder is not particularly limited, and may include, for example, polyvinylidene fluoride (PVDF).

The composite layer 22 may include an amount of about 50% to 70% by weight of the carbon material, an amount of about 20% to 40% by weight of the metal, and an amount of about 1% to 10% by weight of the binder, based on the total weight of the composite layer.

The solid electrolyte layer 30 may be a component which is interposed between the cathode 10 and the anode 20 to allow lithium ions to move between the two components.

The solid electrolyte layer 30 may suitably include an oxide solid electrolyte or a sulfide solid electrolyte. Preferably, the sulfide solid electrolyte having high lithium ion conductivity may be used in the solid electrolyte layer 30. The sulfide solid electrolyte is not particularly limited, and may suitably include one or more selected from the group consisting of Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is one of Ge, Zn, and Ga), Li2S-GeS2, Li2S-SiS2-Li3PO4, Li₂S—SiS₂—LiₓMO_{y} (wherein x and y are positive numbers and M is one of P, Si, Ge, B, Al, Ga, and In), and Li₁₀GeP₂Si₂.

### EXAMPLE

Hereinafter, the present invention will be described in more detail with reference to specific examples. However, the following examples are provided only for better understanding of the present invention, and thus should not be construed as limiting the scope of the present invention.

### Example and Comparative Examples 1 to 4

A carbon material having the physical properties shown in Table 1 was prepared. A composite layer containing 65% by weight of the carbon material, 30% by weight of a silver (Ag) powder, and 5% by weight of polyvinylidene fluoride was formed on an anode current collector to obtain an anode.

TABLE 1

| | | Average | Electrical | | BET |
|---|---|---|---|---|---|
| | | particle | conduc- | Packing | specific |
| | | diameter | tivity | density | surface area |
| Item | Shape | [nm] | [S/m] | [g/cc] | [m²/g] |
| Example | Spherical | 250~300 | 27.5 | 1.86 | 24 |
| Comparative | Agglom- | <30 | 79.5 | 1.14 | 61 |
| Example 1 | erated | | | | |
| Comparative | Agglom- | 30~50 | 52.6 | 1.21 | 182 |
| Example 2 | erated | | | | |
| Comparative | Agglom- | <30 | 49.5 | 1.21 | 91.1 |
| Example 3 | erated | | | | |
| Comparative | Agglom- | 70~200 | 36.1 | 1.59 | 32.7 |
| Example 4 | erated | | | | |

A cathode active material, a solid electrolyte, a conductive material, a binder, a dispersant, and a solvent were mixed together to obtain a slurry. The slurry was applied on a cathode current collector and dried to prepare a cathode.

A solid electrolyte, a binder, and a solvent were mixed together, and the resulting mixture was applied to the cathode, followed by drying, to obtain a solid electrolyte layer.

The cathode, the solid electrolyte layer, and the anode were stacked as shown in FIG. 1 to produce an all-solid-state battery.

### Experimental Example 1—Scanning Electron Microscopy

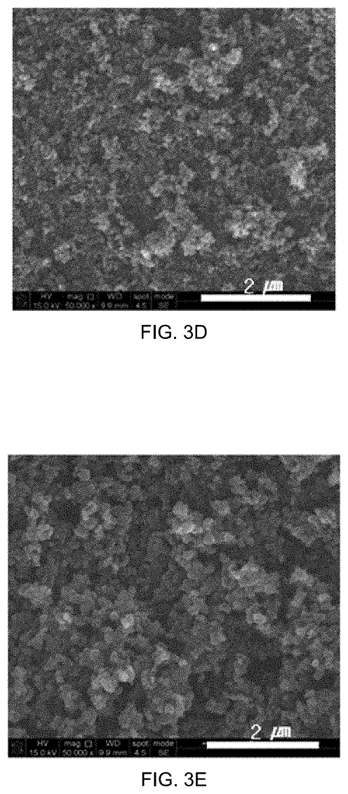

The carbon materials used in Example and Comparative Examples 1 to 4 were analyzed with a scanning electron microscope (SEM). The results are shown in FIGS. 3A to 3E.

The carbon material of Example (FIG. 3A) was present in the form of spherical primary particles, whereas the carbon materials of Comparative Examples 1 to 4 (FIGS. 3B to 3E) were present in the form of agglomerates.

### Experimental Example 2—Analysis of Nitrogen Adsorption/Desorption Characteristics

The isothermal adsorption-desorption characteristics of nitrogen gas for the composite layers of Example and Comparative Examples 1 to 4 were analyzed.

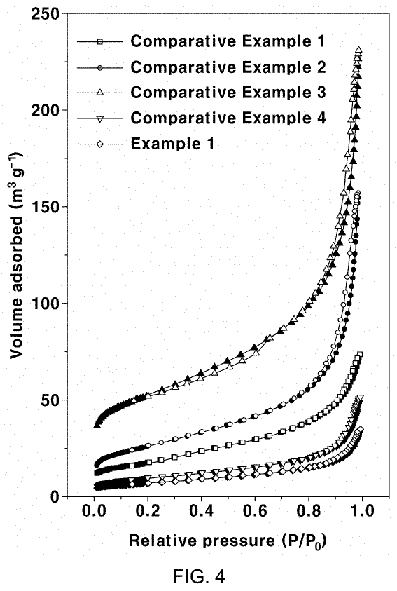

Specifically, the amount of nitrogen gas adsorbed onto the composite layer according to the relative pressure was measured while nitrogen gas was adsorbed and desorbed, and the boiling point of nitrogen gas was maintained at 77 K. The results are shown in FIG. 4.

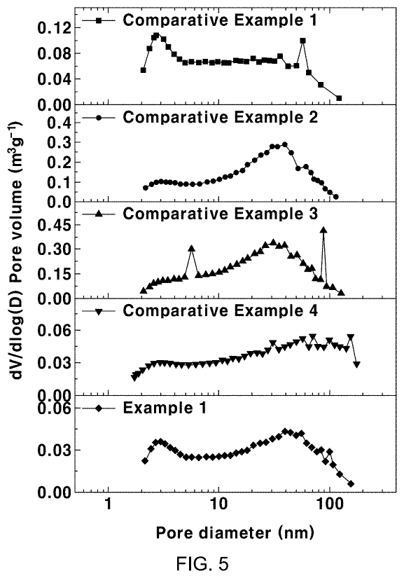

In addition, FIG. 5 shows a graph showing pore size distribution derived using the Barrett-Joyner-Halenda (BJH) method based on the isothermal desorption data of the nitrogen gas.

As shown in FIG. 5, the volume of nitrogen that was adsorbed and the pore volume were the smallest for Example, which means that the BET specific surface area and the pore volume of the composite layer of Example were the smallest. The result indicates that the lithium ions in the composite layer in Example according an exemplary embodiment of the present invention may move more smoothly than in Comparative Examples 1 to 4.

### Experimental Example 3—Analysis of Charge and Discharge Characteristics

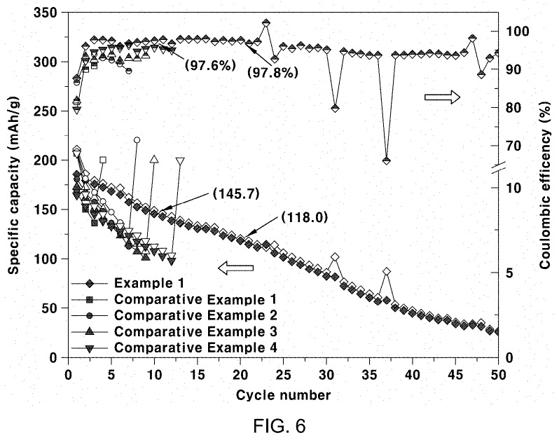

The charge/discharge efficiency (coulombic efficiency) and lifespan of the all-solid-state batteries according to Examples and Comparative Examples 1 to 4 were measured. The results are shown in FIG. 6.

As shown in FIG. 6, Comparative Examples 1 to 4 exhibited deterioration from the beginning of charging and discharging and fewer than 15 charge/discharge cycles, whereas Example exhibited 50 or more charge/discharge cycles. In addition, Example showed an average coulombic efficiency of about 95%.

According to various exemplary embodiments of the present invention, the pores in the composite layer may be minimized by adjusting the shape of the carbon material constituting the composite layer of the anode for an all-solid-state battery to a spherical shape. As a result, a migration path of lithium ions can be smoothly formed in the composite layer.

According to various exemplary embodiments of the present invention, the pores in the composite layer may be minimized and the migration distance of lithium may be reduced by adjusting the average particle diameter of the carbon material constituting the composite layer of the anode for an all-solid-state battery to about 250 nm to 350 nm. As a result, lithium can be delivered more quickly.

According to various exemplary embodiments of the present invention, lithium may be formed between the composite layer and the anode current collector, not between the composite layer and the solid electrolyte layer, by adjusting the electrical conductivity of the carbon material constituting the composite layer of the anode for an all-solid-state battery to about 30 S/m or less. As a result, the all-solid-state battery can be stably charged and discharged.

The effects of the present invention are not limited to those mentioned above. It should be understood that the effects of the present invention include all effects that can be inferred from the description of the present invention.

The present invention has been described in detail with reference to preferred exemplary embodiments. However, it will be appreciated by those skilled in the art that changes may be made in these examples without departing from the principles and spirit of the present invention, the scope of which is defined in the appended claims and their equivalents.

What is claimed is:

1. An anode for an all-solid-state battery comprising:
an anode current collector; and
a layer disposed on the anode current collector and comprising a carbon material and a metal capable of being alloyed with lithium,
wherein the carbon material comprises a plurality of primary particles that do not agglomerate.

2. The anode according to claim 1, wherein the carbon material comprises spherical particles.

3. The anode according to claim 1, wherein the carbon material has an average particle diameter of about 250 nm to 350 nm.

4. The anode according to claim 1, wherein the carbon material has an electrical conductivity of about 30 S/m or less.

5. The anode according to claim 1, wherein the carbon material has a packing density of about 1.5 g/cc or greater.

6. The anode according to claim 1, wherein the carbon material has a BET specific surface area of about 25 m²/g or less.

7. The anode according to claim 1, wherein a total pore volume of the carbon material, obtained through nitrogen adsorption isotherm measurement, is about 0.001 cm³/g to 0.4 cm³/g.

8. The anode according to claim 1, wherein the metal comprises one or more selected from the group consisting of gold (Au), platinum (Pt), palladium (Pd), silicon (Si), silver (Ag), aluminum (Al), bismuth (Bi), tin (Sn), and zinc (Zn).

9. The anode according to claim 1, wherein the composite layer further comprises a binder, and comprises an amount of about 50% to 70% by weight of the carbon material, an amount of about 20% to 40% by weight of the metal, and an amount of about 1% to 10% by weight of the binder, all % by weight based on the total weight of the composite layer.

10. An all-solid-state battery comprising:
a cathode;
an anode according to claim 1; and
a solid electrolyte layer interposed between the anode and the cathode,
wherein the solid electrolyte layer is stacked such that the solid electrolyte layer contacts a composite layer of the anode.

11. A vehicle comprising a battery of claim 10.
